(19) United States
(12) Patent Application Publication
(10) Pub. No.: US 2007/0110914 A1
(43) Pub. Date: May 17, 2007

(54) Wire harness arranging-purpose wire holding member and wire harness arranging-method

(75) Inventors: Mamoru Masukawa, Shizuoka (JP); Masayuki Sato, Shizuoka (JP); Hiroshi Kishita, Shizuoka (JP); Mitsuaki Saito, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/640,255

(22) Filed: Dec. 18, 2006

Related U.S. Application Data
(62) Division of application No. 10/199,494, filed on Jul. 22, 2002.

(30) Foreign Application Priority Data
Jul. 23, 2001 (JP) P2001-221740
Jul. 23, 2001 (JP) P2001-221742
Jul. 24, 2001 (JP) P2001-223128
Jul. 24, 2001 (JP) P2001-223129
Jul. 26, 2001 (JP) P2001-226154

(51) Int. Cl. B05C 11/11; B05D 1/18

(52) U.S. Cl. 427/434.6; 118/504

(57) ABSTRACT

In a wire harness-arranging method, a wire group at a predetermined portion of a wire harness, comprising a plurality of wires bundled together, is untied, and is arranged so as to be coated with a water stop agent. The wire harness is supported above an installation plate through a plurality of wire group support jigs mounted upright on the installation plate, in spaced relation to this installation plate. Subsequently, U-shaped wire holding members, each having a slit of a uniform width over an entire length thereof, are brought respectively into gripping engagement with those portions of the wire group, disposed respectively at opposite ends of the predetermined portion of the wire harness spaced from each other in a wire-installing direction, from an upper side of the installation plate, so that the wire group at the predetermined portion is arranged along each of the slits in an upward-downward direction.

The present application is based on Japanese Patent Applications No. 2001-221740, No. 2001-221742, No. 2001-223128, No. 2001-223129 and No. 2001-226154, which are incorporated herein by reference.

### BACKGROUND OF THE INVENTION

1. Field of the Invention

This invention relates to a wire harness-arranging method and a wire harness-arranging jig, in which a wire group at a predetermined portion of a wire harness, comprising a plurality of wires bundled together, is untied, and is arranged so as to be coated with a water stop agent. More specifically, the invention relates to a wire harness arranging-purpose wire holding member and a wire harness-arranging method which can be suitably used in the process of arranging a plurality of wires (for example, an automotive wire harness) in a row, and then coating a water stop agent on the wires to fill up gaps between the wires so as to apply a waterproofing treatment to that portion of the wire harness for passing through a grommet mounted on a vehicle body panel.

2. Related Art

For installing a wire harness astride a panel in an automobile, it is a common practice to pass the wire harness through a harness-passing hole in a grommet and then to mount this grommet on the panel. At this time, in order to prevent the intrusion of water from the exterior, a water stop agent is applied to that portion of the wire harness which is to pass through the harness-passing hole in the grommet, thereby filling up gaps between the wires.

There has been proposed such a water-stopping treatment method for obtaining a conventional waterproof structure of the wire harness as shown in FIGS. 19A to 19C.

The wire harness W, shown here, is used in the electric wiring for an automobile, and when a group of wires are shaped into an installation form, corresponding to an installation form on the vehicle, a waterproofing treatment is applied to those portions of the wires which are to be passed through a grommet 3 adapted to be mounted in a through hole formed in a vehicle body panel of the automobile.

More specifically, first, the grommet 3 is mounted on a predetermined portion of the wire harness W as shown in FIG. 19A, and then a water stop agent 6 in an unsolidified state is filled in a gap between an inner surface of a harness-passing hole 3a in the grommet 3 and the group of wires 4 as shown in FIG. 19B, and is allowed to stand for a predetermined period of time, so that the water stop agent is solidified, thereby providing a waterproof structure in which the gap between the group of wires 4 and the grommet 3 is filled up by the solidified water stop agent 6, as shown in FIG. 19C.

In such a wire harness-producing method, however, a very small gap remains between any two adjacent wires 4 at the grommet-passing portion of the wire group, and therefore there is a fear that external rain water intrudes along the wires 4 because of a capillary phenomenon of these very small gaps, and this has invited a problem that a sufficient waterproof effect can not be obtained.

In other words, in this water-stopping treatment method, the water stop agent 6 was poured, with the grommet 3 mounted on the wire harness 1, and therefore the water stop agent 6 could not sufficiently penetrate into the gaps or interstices between the wires 4 in a harness-passing hole 3b in the grommet 3 and the gap between the group of wires 4 and the inner surface of the harness-passing hole 3b, and a considerable number of very small gaps remained in the cured water stop agent 6. And besides, the water stop agent 6 of a considerably-low viscosity must be used so that this water stop agent 6 can sufficiently penetrate into these gaps. However, if the proper viscosity fails to be chosen, the water stop agent 6 flows down from the harness-passing hole 3b, so that similar gaps are formed.

Therefore, in order to seal the gaps or interstices between the wires 4, there has been proposed a producing method shown in FIGS. 20 to 21F.

The wire harness-producing method, shown here, is disclosed in JP-A-10-224960, and a plurality of wire group support jigs 15a, 15b, 15c, 15d, 15e, . . . for supporting a wire group of a wire harness W in a branched pattern, corresponding to a predetermined installation form, as well as an arranging jig 13 for coating a water stop agent for waterproofing purposes, are beforehand fixedly mounted on an installation plate 11 which is used for preforming or shaping the wire group of the wire harness W into the predetermined installation form corresponding to an installation form on a vehicle.

The arranging jig 13 comprises a base member 13a, fixedly mounted on the installation plate 11, and a pair of wire holding members 14 which are fixedly mounted on the base member 13a, and are spaced a predetermined distance from each other.

Each of the wire holding members 14 has a wire-inserting slit 14a having one open end, the slit 14a being formed by a pair of opposed arms 14b and 14c.

The width of the slit 14a is so determined as to arrange those portions of the wires, forming a grommet-passing portion of the wire harness W, vertically one upon another in one row.

The distance between the pair of wire holding members 14 is determined in accordance with the length of those portions of the wires of the wire harness W which are to be tied together into a waterproof structure.

The waterproof structure of the grommet-passing portion of the wire harness, utilizing the arranging jig 13, is formed according to the procedure of FIGS. 21A to 21F.

Namely, first, grommet-passing portions of the wires of the wire harness W are inserted one by one into the slit 14a of each of the two wire holding members 14 and 14, and the grommet-passing portions of the group 16 of wires are arranged vertically in a row in a plane, as shown in FIG. 21A. Then, a water stop agent 19 in an unsolidified state is applied to one surface of that portion of the arranged wire group 16, disposed between the pair of slits 14a, by a water stop agent-coating nozzle 18 as shown in FIG. 21B, and at this time, the water stop agent 19 penetrates into a gap between any two adjacent wires. Generally, moisture-curing silicone RTV is used as the water stop agent 19.

Then, a band-like film 21 for bundling the wire group 16 is bonded to the one surface of the wire group 16, coated with the water stop agent 19, thereby interconnecting the wires in such a manner that these wires are kept arranged in one row, and thereafter the arranging jig 13 is moved downward, thereby removing the wire group 16 from the arranging jig 13, as shown in FIG. 21C.

Then, the band-like film 21 is wound tight to tie the wire group 16 into a wire bundle of a round cross-section, as shown in FIG. 21D. Further, a tape 23 is wound on that portion of the wire bundle, tied by the band-like film 21, thereby forming the wire bundle into such a circular cross-sectional shape and size that the wire bundle can be snugly fitted into a harness-passing hole in a grommet, as shown in FIG. 21E, and the water stop agent is solidified. Thereafter, the grommet 25 is mounted on that portion of the wire bundle having the tape 23 wound thereon, as shown in FIG. 21F.

With this water-stopping treatment method, the water stop agent can easily penetrate into the gaps between the wires, and therefore the good waterproof structure can be obtained.

In recent years, however, an increased number of on-vehicle electrical equipments and electrical circuits have been used, and therefore the number of wires, forming the wire harness W, has much increased, and the operation for inserting the wires one by one into the slit 14a of each of the pair of spaced-apart wire holding members 14 and 14 has required much time and labor, and this has been the cause of the lowered productivity of the wire harness.

More specifically, the group of wires 16 must be inserted one by one into the slit 14c in each wire holding member 14 as shown in FIG. 21A, and besides the width of the slit 14c is slightly larger than the diameter of the wire so that the group of wires 16 can be held in a plane, and therefore much time and labor are often required for the operation for inserting the group of-wires 16 into the slit 14c.

Further, the width of the slit 14c is uniform over the entire length thereof, and therefore inconveniently, wires, thicker than this slit 14c, and a bundle of several wires, can not be handled at the same time.

And besides, the slit 14a of each wire holding member 14 for holding or clamping the wires has the fixed width, and therefore when the outer diameter of the wires was changed, new wire holding members, having a corresponding slit width, must be produced, and therefore there was encountered a problem that the requirement for the change of the diameter of the wires of the wire harness and so on could not be rapidly met.

When the number of the wires increased, the arranging jig much projected in the vertical direction, and therefore when installing the wire harness on the installation plate, this arranging jig became an obstacle to this installation. For installing the wire harness in a proper condition, the wire harness must first be inserted into the arranging jig, and therefore the wire group must be inserted into the arranging jig in an incompletely-installed condition of the wire harness, and the support of the wire harness was unstable, so that the efficiency of the operation was low.

And besides, the wire harness, while being bent, was inserted into the upper opening in the arranging jig much projecting in the vertical direction, and therefore there was encountered a problem that after the wire group was completely received in the slit, a slack due to the bending of the wire harness often developed in the wire harness.

Further, simultaneously when the wire harness was installed on the installation plate, the wire group of the wire harness in the unstably-supported condition was forced into the arranging jig much projecting in the vertical direction, and therefore there was encountered a problem that an undue force acted on the wire group, so that the wires were damaged.

In the above wire harness-arranging method, the bundle-like wire group, while being untied, is pushed into the slit of each wire holding member fixedly mounted on the installation plate. Therefore, for example, when that portion of the wire group which was untied into such a condition as to be easily inserted into the slit, was spaced from the open end of the slit, this portion must be moved toward the open end of the slit, and during this movement, the wire group, once untied, was again tied tightly, thus inviting a problem that the efficiency of the insertion of the wire group into the slit was lowered. In this case, much labor was required particularly when producing a large amount of wire harnesses, and this was a main cause of the lowered productivity.

On the other hand, in the arranging jig, a threaded portion was formed at a lower end of a support shaft 27 (shown in FIG. 20) extending downwardly from a lower surface of the arranging jig, and the support shaft 27 was passed through a mounting hole 29 formed through the installation plate 11, and this support shaft was fastened by a nut (not shown) at the reverse side of the installation plate 11. After the coating of the water stop agent was finished, the nut was removed from the support shaft, and the arranging jig was moved downward until it was brought into engagement with the installation plate, and by doing so, the arranging jig was removed from the wire group coated with the water stop agent. When fixing the arranging jig so as to arrange the wire group, the arranging jig must be moved upward, and when removing the arranging jig after the coating of the water stop agent, the arranging jig must be moved downward after removing the nut. Therefore, much labor was required when producing a large amount of wire harnesses, and the efficiency of the operation was lowered.

### SUMMARY OF THE INVENTION

This invention has been made under the above circumstances, and an object of the invention is to provide a wire harness arranging-purpose wire holding member and a wire harness-arranging method, in which a untied wire group can be efficiently inserted into a slit, thereby enhancing the productivity of wire harnesses. In particular, the invention is directed to the requirement for the change of the diameter of the wires to be held by this wire holding member can be rapidly met.

Further, the object of the invention is to provide a water-stopping treatment jig for a wire harness, in which wires can be arranged easily when coating a water stop agent onto the wires, and besides a thick wire and a wire bundle can be handled at the same time.

The other object of the invention is to provide a wire harness-arranging method and a wire harness-arranging jig, in which a slack will not develop in a wire harness, and wires will not be damaged. Also the invention is to provide a wire harness-arranging method and a wire harness-arranging jig, in which a wire group can be arranged easily, and the jig can be easily fixed and removed.

(1) In the invention, there is provided a wire arranging method for untying and arranging wires of a wire harness at a predetermined portion comprising the steps of:

arranging said wires for coating with a water stop agent,

supporting said wire harness with a plurality of wire support jigs mounted upright on an installation plate so as to be spaced from said installation plate;

clamping the predetermined portion of said wires with a U-shaped wire holding member having a slit of a uniform width over an entire length thereof from an upper side of said installation plate; and

arranging said wires along said slit in a vertical direction.

In this wire harness-arranging method, the wire harness is supported above the installation plate in spaced relation thereto, and then the pair of U-shaped wire holding members, each having the slit of a uniform width, are brought respectively into clamping engagement with those portions of the wire group, disposed respectively at the opposite ends of the predetermined portion of the wire harness spaced from each other in the wire-installing direction, from the upper side of the installation plate. By doing so, the wire group at the predetermined portion are arranged along the slits of the wire holding members in the upward-downward direction. Therefore, even when the number of the wires increases, it is not necessary to install the wire harness while inserting the wire harness into the arranging jig much projecting in the vertical direction, and therefore the efficiency of the wire-arranging operation is enhanced. And besides, it is not necessary to insert the wire harness into the arranging jig, much projecting in the vertical direction, while bending the wire harness, and therefore a slack will not develop in the wire harness. Each wire holding member is brought into clamping engagement with the wire group, already supported on the installation plate, from the upper side, so that the wire group, while gradually disintegrated, can be inserted into the slit. Therefore, in contrast with the case where the bundle-like wire group is forced into the arranging jig, the wires are less liable to be damaged.

(2) In the invention, there is provided a wire harness-arranging method according to (1), wherein a plurality of kinds of wire holding members having the slits of different widths are provided, and a thickness of the wires at the predetermined portion in a direction perpendicular to a wire-arranging direction is set to be a desired one of different thicknesses by selecting a desired one of said wire holding members.

In this wire harness-arranging method, by selecting a desired one of the wire holding members having different slit widths, the predetermined portion of the wire group, clamped by the wire holding members, is arranged in such a manner that the thickness thereof corresponds to the width of the slit of the selected wire holding member. In this case, merely, a selected one of the plurality of kinds of wire holding members is used, and therefore the wire holding member does not need to be attached and detached relative to the installation plate, and the predetermined portion can be easily arranged into a desired one of the different thicknesses. Even in the case where the wire group comprises wires of the same diameter, the wire group at the predetermined portion 142 can be easily arranged in a desired number of row(s), such for example as one row or two rows.

(3) In the invention, there is provided a wire harness-arranging jig wherein wires of a wire harness is untied and arranged at a predetermined portion so as to be coated with a water stop agent, comprising:

a wire holding member including a U-shaped forming portion having a slit of a uniform width and an open distal end; and

a handle portion extending from a rear end of said forming portion remote from said open end thereof, said forming portion being adapted to arrange said wires along said slit;

wherein the uniform width of said slit is substantially equal to a thickness of the wires at said predetermined portion in a direction perpendicular to a direction of arrangement of said wires.

In this wire harness-arranging jig, the forming portions of the wire holding members are gradually brought respectively into clamping engagement with those portions of the wire harness, disposed respectively at the opposite ends of the predetermined portion of the wire harness, from the upper side of the wire group, with each handle portion grasped by the hand, and the bundle-like wire group, while gradually disintegrated, can be inserted into the slit therealong without an undue force. As a result, the predetermined portion of the wire group, clamped at its opposite ends respectively by the wire holding members, can be arranged in the upward-downward direction in such a manner that the arranged wire group has the predetermined thickness.

(4) In the invention, there is provided a wire harness-arranging method wherein a wire group at a predetermined portion of a wire harness is untied and arranged so as to be coated with a water stop agent, comprising the steps of:

supporting said wire harness above an installation plate with a plurality of wire group support jigs mounted upright on said installation plate so as to be spaced from said installation plate;

contacting an inner side of a longer leg portion of a U-shaped wire holding member having a slit of a uniform width formed between said longer leg portion and a shorter leg portion with the predetermined position of said wire group; and

introducing and arranging said wire group in said slit while kept in sliding contact with said longer leg portion.

In the wire harness-arranging method of the present invention, the wire harness is supported on the installation plate, and then the inner sides of the longer legs portions of the wire holding members are brought respectively into contact with those portions of the wire group disposed respectively at the opposite ends of the predetermined portion of the wire harness spaced from each other in the wire-installing direction, and the wire group, while kept in sliding contact with the longer leg portion, is introduced into the slit, and is arranged in the slit. Namely, while the wire holding member, held by one hand, and the wire group, held by the other hand, are moved relative to each other, the wires can be sequentially introduced into the slit. Therefore, as compared with the case where the bundle-like wire group is pushed into the slit of the arranging jig, fixedly mounted on the installation plate, by moving only the wire group, the efficiency of the insertion of the wire group into the slit can be enhanced.

(5) In the invention, there is provided a wire harness-arranging method according to (4), wherein a plurality of kinds of wire holding members having the slits of different widths are provided, and a thickness of the arranged wire group of said predetermined portion in a direction perpendicular to a wire-arranging direction can be a desired one of different thicknesses by selecting a desired one of said wire holding members.

In this wire harness-arranging method, by selecting a desired one of the wire holding members having different slit widths, the predetermined portion of the wire group, clamped by the wire holding members, is arranged in such a manner that the thickness thereof corresponds to the width of the slit of the selected wire holding member. In this case, merely, a selected one of the plurality of kinds of wire holding members is used, and therefore the wire holding member does not need to be attached and detached relative to the installation plate, and the predetermined portion can be easily arranged into a desired one of the different thicknesses. Even in the case where the wire group comprises wires of the same diameter, the wire group at the predetermined portion 142 can be easily arranged in a desired number of row(s), such for example as one row or two rows.

(6) In the invention, there is provided a wire harness-arranging jig wherein a wire group at a predetermined portion of a wire harness provided with a plurality of bundled wires, is untied and arranged for coating a water stop agent; comprising:

a wire holding member provided with a pair of leg portions forming a slit of a uniform width therebetween and a handle portion extending from rear ends of said leg portions;

wherein said width of said slit is substantially equal to a thickness of the arranged wire group at said predetermined portion in a direction perpendicular to a direction of arrangement of said wire group, and said leg portions are different in length from each other.

In this arranging jig, the bundle-like wire group is brought into contact with the inner side of the longer leg portion, and while the untied wire group and the wire holding member are both moved, the wires can be introduced into the slit along the longer leg portion. Therefore, the wire holding member can be moved to that portion of the untied wire group which can be easily introduced, thereby directing the opening between the leg portions toward this portion. Therefore, as compared with the case where the bundle-like wire group is pushed into the slit of the arranging jig, fixedly mounted on the installation plate, by moving only the wire group, the wires can be more efficiently introduced into the slit.

(7) In the invention, there is provided a wire harness-arranging method according to (1), further comprising the step of:

inserting one of a pair of leg portions of said wire holding member forming said slit therebetween into a fixing hole formed in said installation plate, thereby fixing said wire holding member to said installation plate.

In this wire harness-arranging method, the wire harness is supported above the installation plate in spaced relation thereto, and then the pair of U-shaped wire holding members, each having the slit of a uniform width, are brought respectively into clamping engagement with those portions of the wire group, disposed respectively at the opposite ends of the predetermined portion of the wire harness spaced from each other in the wire-installing direction, from the upper side of the installation plate. By doing so, the wire group at the predetermined portion are arranged along the slits of the wire holding members in the upward-downward direction. Therefore, even when the number of the wires increases, it is not necessary to install the wire harness while inserting the wire harness into the arranging jig much projecting in the vertical direction, and therefore the efficiency of the wire-arranging operation is enhanced. And besides, it is not necessary to insert the wire harness into the arranging jig, much projecting in the vertical direction, while bending the wire harness, and therefore a slack will not develop in the wire harness. One of the pair of leg portions of the wire holding member, forming the slit therebetween, is inserted into the fixing hole formed in the installation plate, and by doing so, the wire holding member can be fixed to the installation plate. Therefore, when arranging the wire group, the leg portion is inserted into the fixing hole, and after the coating of the water stop agent, the leg portion is removed from the fixing hole, and merely by doing so, the fixing and removal of the wire holding member can be effected easily, thereby enhancing the efficiency of the operation.

(8) In the invention, there is provided a wire harness-arranging method according to (7), wherein there are provided a plurality of kinds of wire holding members having the slits of different widths, and by selecting a desired one of said wire holding members, a thickness of the arranged wire group of said predetermined portion in a direction perpendicular to a wire-arranging direction can be a desired one of different thicknesses.

In this wire harness-arranging method, by selecting a desired one of the wire holding members having different slit widths, the predetermined portion of the wire group, clamped by the wire holding members, is arranged in such a manner that the thickness thereof corresponds to the width of the slit of the selected wire holding member. In this case, merely, a selected one of the plurality of kinds of wire holding members is used, and therefore the wire holding member does not need to be attached and detached relative to the installation plate, and the predetermined portion can be easily arranged into a desired one of the different thicknesses. Even in the case where the wire group comprises wires of the same diameter, the wire group at the predetermined portion 142 can be easily arranged in a desired number of row(s), such for example as one row or two rows.

(9) In the invention, there is provided a wire harness-arranging device wherein a wire group at a predetermined portion of a wire harness comprising a plurality of bundled wires is untied and arranged for coating a water stop agent; comprising:

a wire holding member including
a U-shaped forming portion having a pair of leg portions of different lengths forming a slit with a uniform width therebetween and an open distal end, and
a handle portion extending from a rear end of said forming portion remote from said open end thereof,
said forming portion being adapted to arrange said wire group along said slit, and the uniform width of said slit being substantially equal to a thickness of the arranged wire group of said predetermined portion in a direction perpendicular to a direction of arrangement of said wire group;

an installation plate including a plurality of wire group support jigs mounted thereon for supporting said wire group in a branched pattern corresponding to a predetermined installation form,

wherein a fixing hole is formed on said installation plate for receiving a distal end of the longer leg portion of said wire holding member at at least a position corresponding to one of both ends of said predetermined portion in a wire-installing direction.

In this wire harness-arranging jig, the forming portions of the wire holding members are gradually brought respectively into clamping engagement with those portions of the wire harness, disposed respectively at the opposite ends of the predetermined portion of the wire harness, from the upper side of the wire group, with each handle portion grasped by the hand, and the bundle-like wire group, while gradually disintegrated, can be inserted into the slit therealong without an undue force. As a result, the predetermined portion of the wire group, clamped at its opposite ends respectively by the wire holding members, can be arranged in the upward-downward direction in such a manner that the arranged wire group has the predetermined thickness. Then, the one leg portion of the wire holding member is inserted into the fixing hole, with the wire group received in the slit, and by doing so, the wire holding member, arranging the wire group, can be easily fixed to the installation plate. The wire holding member can be easily detached from the wire group by removing the leg portion from the fixing hole.

(10) In the invention, there is provided a wire harness-arranging device according to (9), wherein the fixing holes are provided on positions corresponding to both ends of said predetermined portion in the wire-installing direction.

(11) In the wire harness-arranging jig according to (3), the forming portion may include

a first arm extending in a direction intersecting the wires; and

a second arm which is opposed to said first arm and is spaced such a distance from said first arm so that said wires pass between said first and second arms;

wherein said second arm is supported on said first arm in such a manner that a distance between said first and second arms is reduced to a value substantially equal to a diameter of said wires, and said first and second arms can clamp and hold said wires of said wire harness therebetween.

(12) In the invention, there is provided a wire arranging method for a wire harness comprising the steps of:

providing a wire holding member according to (11);

widening a distance between said first and second arms of said wire holding member so as to be substantially equal to an outer diameter of said wire harness;

passing a plurality of wires of said wire harness at a predetermined position between said first and second arms;

shortening the distance between said first and second arms so as to press said wires; and

arranging said wires in a row.

In the wire harness arranging-purpose wire holding member of the above construction and the wire harness-arranging method, the distance between the first and second arms of the wire holding member is beforehand made larger than the outer diameter of the bundle of wires forming the wire harness, and by dosing so, the plurality or wires of the wire harness can be held by the wire holding member at a time by one inserting operation, and therefore in contrast with the conventional wire holding member having the fixed slit width, it is not necessary to pass the wires one by one through the slit.

After the bundle of wires of the wire harness are passed between the first and second arms of the wire holding member, the distance between the first and second arms of the wire holding member is reduced, and with this simple operation, the plurality of wires, held by the wire holding member, can be easily arranged in one row.

Even when the diameter of the wires to be held by the wire holding member is changed, this can be easily dealt with merely by adjusting the distance between the first and second arms since this distance between the two arms is adjustable. Thus, the wire holding member has the enhanced general-purpose ability, and therefore the requirement for the change of the diameter of the wires of the wire harness and so on can be rapidly met without the need for producing a new wire holding member.

When a portion, arranged in a row, is to be formed on the wire harness over a predetermined length thereof, for example, for coating a water stop agent, there are used two wire holding members described above.

First, the wires are arranged in a row by the two wire holding members disposed near to each other, and then one wire holding member is slid along the thus held wires, thereby increasing the distance between the two wire holding members into a predetermined value.

(13) In the invention, there is provided a wire harness water-stopping treatment jig for forming a grommet-passing portion of a wire harness with a waterproof structure when a plurality of wires are tied into a predetermined installation form, comprising;

a pair of opposed wire support piece portions;

wherein a distal end portion of at least one of said wire support piece portions is slanting gradually away from the other of said wire support piece portions over a predetermined length.

In the above water-stopping treatment jig, the distal end portion of the one wire support piece portion is slanting to provide a wide opening, and therefore the insertion of the wires into this jig can be effected quite easily. And besides, a thick wire and a wire bundle can be received by this slanting distal end portion, and can be fixed, and therefore various kinds of wires can be handled at the same time.

(14) In the above wire harness water-stopping treatment jig, a width of a slit between said pair of wire support piece portions is slightly larger than an outer diameter of said wires, and a distance from a bottom of said slit to an inclination-starting point of said slanting portion is determined in accordance with a number of the wires.

### BRIEF DESCRIPTION OF THE DRAWINGS

FIG. 1 is a perspective view of a arranging jig for performing a wire harness-arranging method of a preferred embodiment (first embodiment) of the invention.

FIG. 2 is a perspective view of a wire holding member shown in FIG. 1;

FIG. 3A is a perspective view of a wire group before this wire group is arranged, and FIG. 3B is an explanatory view showing the cross-section of this wire group;

FIG. 4 is a perspective view showing a condition in which the wire group is arranged by the wire holding member;

FIGS. 5A and 5B are explanatory, cross-sectional views showing examples of arrangement of the wire group, respectively;

FIG. 6 is a perspective view of an arranging jig for performing a wire harness-arranging method of a modification of the first embodiment;

FIG. 7 is a perspective view of a wire holding member shown in FIG. 6;

FIG. 8A to 8C are views explanatory of the process of introducing the wire group into a slit;

FIG. 9 is a perspective view showing the wire group arranged by the wire holding member;

FIGS. 10A and 10B are perspective views showing the wire group arranged by the wire holding member in a modification of the first embodiment;

FIG. 11 is a perspective view of one preferred embodiment (second embodiment) of a wire harness arranging-purpose wire holding member of the present invention;

FIG. 12 is a cross-sectional view of a wire harness taken along the line A-A of FIG. 11;

FIG. 13 is a perspective view showing a condition in which wires of the wire harness are arranged in a row by the wire harness arranging-purpose wire holding member of FIG. 11;

FIG. 14 is a cross-sectional view of the wire harness taken along the line B-B of FIG. 13;

FIG. 15 is a plan view showing a preferred embodiment (second embodiment) of a water-stopping treatment jig of the present invention;

FIGS. 16A and 16B are perspective views showing a mode of use of the water-stopping treatment jig of FIG. 15;

FIG. 17 is a perspective view showing another mode of use of the water-stopping treatment jig of FIG. 15;

FIG. 18 is a plan view of another embodiment (third embodiment) of a water-stopping treatment jig of the invention;

FIGS. 19A to 19C are views explanatory of the procedure of applying a waterproofing treatment to a grommet-passing portion of a wire harness in a conventional method;

FIG. 20 is a perspective view showing the construction of an arranging jig used in another conventional wire-harness producing method; and

FIGS. 21A to 21F are views explanatory of the procedure of applying a waterproof treatment to a grommet-passing portion of a wire harness, using the arranging jig of FIG. 20.

### DETAILED DESCRIPTION OF THE PREFERRED EMBODIMENTS

### First Embodiment

The first embodiment will now be described in detail with reference to the drawings.

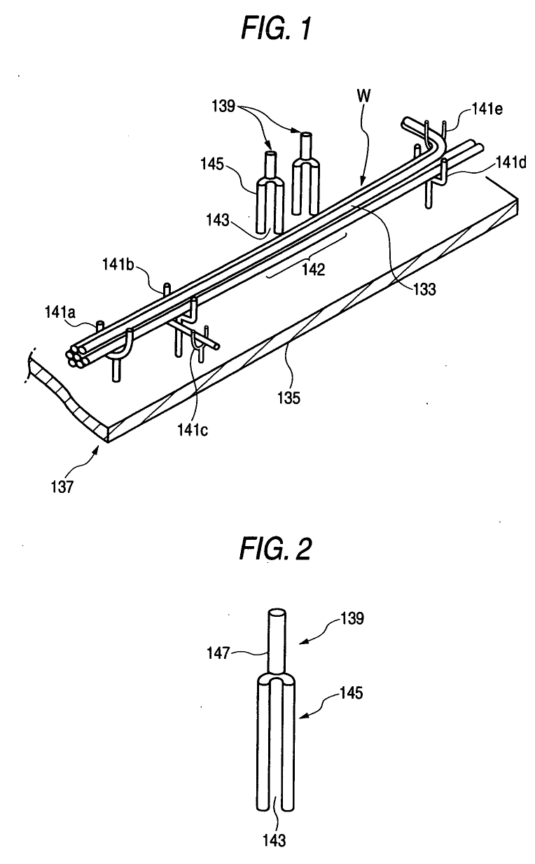

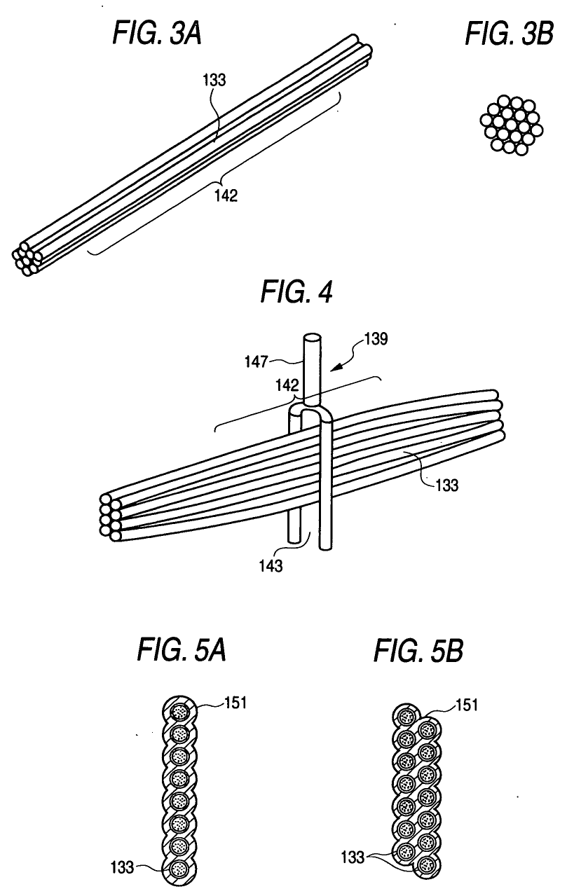

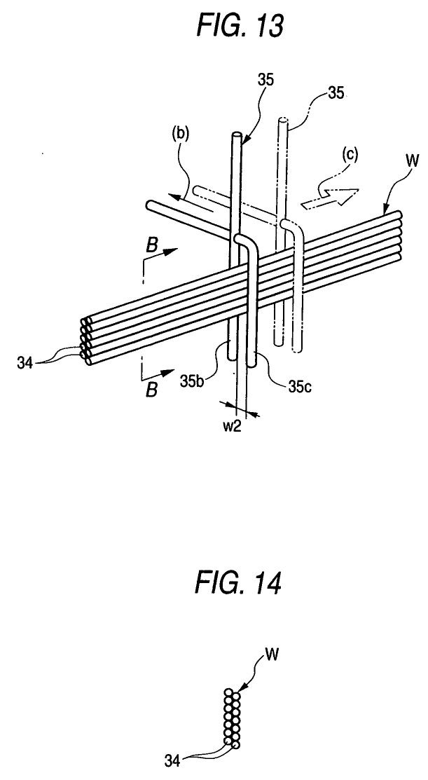

FIG. 1 is a perspective view of the arranging jig for performing the wire harness-arranging method of the invention, FIG. 2 is a perspective view of a wire holding member shown in FIG. 1, FIG. 3A is a perspective view of a wire group before this wire group is arranged, FIG. 3B is an explanatory view showing the cross-section of this wire group, FIG. 4 is a perspective view showing a condition in which the wire group is arranged by the wire holding member, and FIGS. 13A and 13B are explanatory, cross-sectional views showing examples of arrangement of the wire group, respectively.

A wire harness W to be arranged in this embodiment is used in the electric wiring for an automobile, and when the wire group 133, forming the wire harness W, is shaped in a branched manner into an installation form, corresponding to an installation form on the vehicle, on an installation plate 135, those portions of wires at a predetermined portion (grommet-passing portion) of the wire harness for passing through a grommet, adapted to be mounted in a through hole in a vehicle body panel of the automobile, are arranged parallel to one another as shown in FIG. 1, and thereafter a water stop agent is coated onto the predetermined portion, thereby forming the predetermined portion into a wire bundle of a waterproof structure.

For performing the method of this embodiment for arranging the wire harness W, the arranging jig 137, shown in FIG. 1, is used. The arranging jig 137 comprises the installation plate 135, and the wire holding members 139. The installation plate 135 is substantially similar in construction to the conventional installation plate, and differs therefrom in that the installation plate 135 is not provided with the arranging jig 13 of FIG. 20. More specifically, a plurality of wire group support jigs 141a, 141b, 141c, 141d, 141e, . . . for supporting the wire group 133 in a branched pattern, corresponding to the predetermined installation form, are mounted on the installation plate 135.

The predetermined portion 142 of the wire harness W to be subjected to a waterproofing treatment is disposed between the wire group support jigs 141b and 141d, and is supported above the installation plate 135 in spaced relation thereto. As shown in FIG. 2, the wire holding member 139 includes a forming portion 145 of a U-shape, having a slit 143 of a uniform width and an open distal end, and a handle portion 147 extending from a rear end of this forming portion 145 remote from the open end thereof. The width of the slit 143 is substantially equal to the thickness of the arranged wire group 133 of the predetermined portion 142 of the wire harness W in a direction perpendicular to the direction of arrangement of the wire group 133.

Two wire holding members 139 are used for arranging the predetermined portion 142 of the wire harness W. Namely, in use, the wire holding members 139, each having its open end directed downward, are brought respectively into clamping engagement with those portions of the wire group 133, disposed respectively at opposite ends of the predetermined portion 142 spaced from each other in the wire-installing direction, from the upper side, as shown in FIG. 1.

Before the arranging operation, the wire group 133 of the predetermined portion 142, supported between the wire group support jigs 141b and 141d, is tied into a bundle as shown in FIG. 3A, and the cross-section of this wire bundle, lying in a plane perpendicular to the axis thereof, is round as shown in FIG. 3B.

Next, the method of arranging the wire harness W by the use of the installation plate 135 and the arranging jig 137 (comprising the wire holding members 139) will be described.

For arranging the predetermined portion 142 of the wire harness W, first, the wire harness W is supported on the installation plate 135 through the wire group support jigs 141a, 141b, 141c, 141d, 141e, . . .

Then, the wire holding member 139, having its open end directed downward, is moved downward from the upper side of the installation plate 135, and is brought into clamping engagement with that portion of the wire group 133 disposed at one of the opposite ends of the predetermined portion 142 (disposed between the wire group support jigs 141b and 141d) spaced from each other in the wire-installing direction, as shown in FIG. 4. During this clamping operation, the wire group 133, tied into the bundle of the round cross-sectional shape, is untied, and the wires are inserted one by one into the slit 143, and are moved upward in the slit 143. Therefore, the wires are fed upward in the slit 143 in the order of insertion of these wires.

The wire group 133 is thus inserted into the slit 143, so that the wire group 133 is arranged in one row in the vertical direction as shown in FIG. 5A. After the wire holding member 139 is thus brought into clamping engagement with that portion of the wire group 133 disposed at the one of the opposite ends of the predetermined portion 142 spaced from each other in the wire-installing direction, the other wire holding member 139 is similarly brought into clamping engagement with that portion of the wire group 133 disposed at the other of the opposite ends of the predetermined portion 142 spaced from each other in the wire-installing direction. As a result, those portions of the wire harness W, disposed respectively at the opposite ends of the predetermined portion 142 spaced from each other in the wire-installing direction, are clamped respectively by the pair of wire holding members 139, so that the predetermined portion 142 is neatly arranged in the vertical direction.

In this condition, the wire holding members 139 are supported by the tension and rigidity of the wire harness W, and do not need to be supported by the hand. Then, in the same manner as the conventional procedure, a water stop agent 151 in an unsolidified state is coated onto the predetermined portion 142 of the wire group 133, arranged in one row by the wire holding members 139, so that this water stop agent 151 can penetrate into gaps between the wires as shown in FIGS. 13A and 13B. This coating is also applied to the reverse surface of the wire group 133 arranged in one row. Generally, moisture-curing silicone RTV is used as the water stop agent 151.

Then, as in the conventional method, a band-like film for bundling the wire group 133 is bonded to one surface of the wire group 133, coated with the water stop agent 151, thereby interconnecting the wires of this wire group 133 in such a manner that this wire group is kept arranged in one row, and thereafter the wire holding members 139 are moved upward, thereby removing the wire group 133 from the wire holding members 139.

Then, the band-like film is wound tight to tie the wire group 133 into a wire bundle of around cross-section. Further, a tape is wound on that portion of the wire bundle, tied by the band-like film, thereby forming the wire bundle into such a circular cross-sectional shape and size that the wire bundle can be snugly fitted into a harness-passing hole in the grommet, and the water stop agent is solidified. Thereafter, the grommet is mounted on that portion of the wire bundle having the tape wound thereon.

In the above method of arranging the wire harness W, the wire harness W is supported above the installation plate 135 in spaced relation thereto, and then the pair of wire holding members 139, each having the slit 143 of a uniform width, are brought respectively into clamping engagement with those portions of the wire group 133, disposed respectively at the opposite ends of the predetermined portion 142 of the wire harness W spaced from each other in the wire-installing direction, from the upper side of the installation plate 135. By doing so, the wire group 133 at the predetermined portion 142 are arranged along the slits 143 of the wire holding members 139 in the vertical direction. Therefore, even when the number of the wires increases, it is not necessary to install the wire harness W while inserting the wire harness into the arranging jig much projecting in the vertical direction, and therefore the efficiency of the wire-arranging operation is enhanced.

It is not necessary to insert the wire group 133 into the arranging jig, much projecting in the vertical direction, while bending the wire group 133, and therefore a slack will not develop in the wire harness W. Each wire holding member 139 is brought into clamping engagement with the wire group 133, already supported on the installation plate 135, from the upper side, so that the wire group 133, while gradually disintegrated, can be inserted into the slit 143. Therefore, in contrast with the case where the bundle-like wire group 133 is forced into the arranging jig, the wires are less liable to be damaged.

In the above arranging jig 137 for arranging the wire harness W, the forming portions 145 of the wire holding members 139 are brought respectively into clamping engagement with those portions of the wire harness W, disposed respectively at the opposite ends of the predetermined portion 142 of the wire harness W, from the upper side of the wire group 133, with each handle portion 147 grasped by the hand, and the bundle-like wire group 133, while gradually disintegrated, can be inserted into the slit 143 therealong without an undue force. As a result, the predetermined portion 142 of the wire group 133, clamped at its opposite ends respectively by the wire holding members 139, can be arranged in the vertical direction in such a manner that the arranged wire group has the predetermined thickness.

A plurality of kinds of wire holding members 139, having slits 143 of different widths, are prepared, and by selecting a desired one of the wire holding members 139, the thickness of the arranged wire group 133 of the predetermined portion 142 of the wire harness W in the direction perpendicular to the wire-arranging direction can be a desired one of different thicknesses.

Namely, by selecting a desired one of the wire holding members 139 having the slits 143 of different widths, the predetermined portion 142 of the wire group 133, clamped by the wire holding members 139, is arranged in such a manner that the thickness thereof corresponds to the width of the slit of the selected wire holding member. In this case, merely, a selected one of the plurality of kinds of wire holding members is used, and therefore the wire holding member 139 does not need to be attached and detached relative to the installation plate 135, and the predetermined portion 142 can be easily arranged into a desired one of the different thicknesses. Therefore, even in the case where the wire group 133 comprises wires of the same diameter, the wire group 133 at the predetermined portion 142 can be arranged in a desired number of row(s), such for example as one row or two rows (see FIG. 5B).

A modification of the first embodiment of the invention will now be described in detail with reference to the drawings.

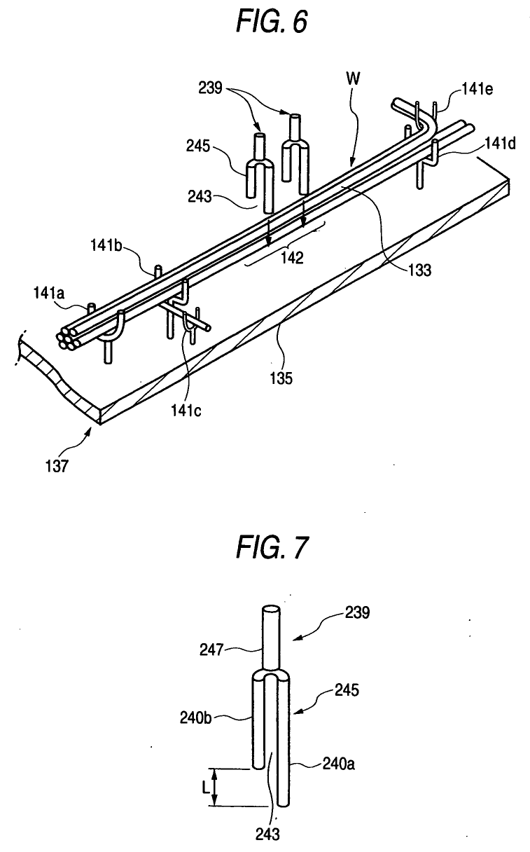

FIG. 6 is a perspective view of the arranging jig for performing the wire harness-arranging method of the modification, FIG. 7 is a perspective view of a wire holding member shown in FIG. 6, FIGS. 16A to 16C are views explanatory of the process of introducing the wire group into a slit, and FIG. 9 is a perspective view showing the wire group arranged by the wire holding member, respectively.

In this modification, as shown in FIG. 7, the wire holding member 239 includes a forming portion 245 of a U-shape, having a slit 243 of a uniform width, formed between a pair of leg portions 240a and 240b of different lengths, and an open distal end, and a handle portion 247 extending from a rear end of this forming portion 245 remote from the open end thereof. The width of the slit 243 is substantially equal to the thickness of the arranged wire group 133 of the predetermined portion 142 of the wire harness W in a direction perpendicular to the direction of arrangement of the wire group 133. The leg portion 240a is longer than the leg portion 240b.

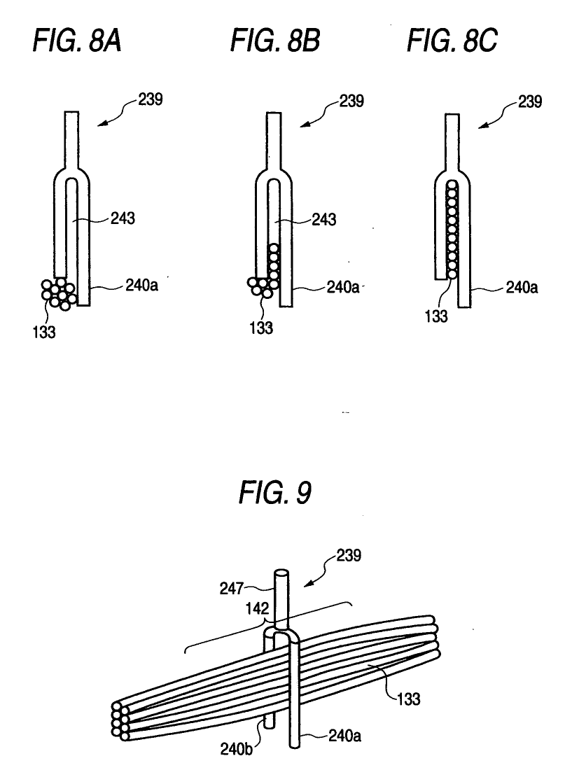

For performing the method for arranging the wire harness W in this modification, the wire holding member 239, having its open end directed downward, is moved downward from the upper side of the installation plate 135, and the inner side of the longer leg portion 240a of the wire holding member 239 is brought into contact with that portion of the wire group 133 disposed at one of the opposite ends of the predetermined portion 142 (disposed between the wire group support jigs 141b and 141d) spaced from each other in the wire-installing direction, as shown in FIG. 8A. Then, while the wire holding member 239, held by one hand, and the untied wire group 133, held by the other hand, are moved relative to each other, with the wire group 133 held in contact with the inner side of the longer leg portion 240a, the wires are introduced into the slit 243 along the longer leg portion 240a as shown in FIG. 8B. Namely, the wire holding member 239 is moved to that portion of the untied wire group 133 which can be easily introduced, thereby directing the opening between the leg portions 240a and 240b toward this portion.

The wire group 133 is thus inserted into the slit 243, so that the wire group 133 is arranged in one row in the vertical direction as shown in FIG. 8C. After the wire holding member 239 is thus brought into clamping engagement with that portion of the wire group 133 disposed at the one of the opposite ends of the predetermined portion 142 spaced from each other in the wire-installing direction, the other wire holding member 239 is similarly brought into clamping engagement with that portion of the wire group 133 disposed at the other of the opposite ends of the predetermined portion 142 spaced from each other in the wire-installing direction. As a result, those portions of the wire harness W, disposed respectively at the opposite ends of the predetermined portion 142 spaced from each other in the wire-installing direction, are clamped respectively by the pair of wire holding members 239, so that the predetermined portion 142 is neatly arranged in the vertical direction.

In the above method of arranging the wire harness W, the wire harness W is supported on the installation plate 135, and then the inner sides of the longer legs portions 240a of the wire holding members 239 are brought respectively into contact with those portions of the wire group 133 disposed respectively at the opposite ends of the predetermined portion 142 of the wire harness W spaced from each other in the wire-installing direction, and the wire group 133, while kept in sliding contact with the longer leg portion 240a, is introduced into the slit 243, and is arranged in the slit. Namely, while the wire holding member 239, held by one hand, and the wire group 133, held by the other hand, are moved relative to each other, the wires can be sequentially introduced into the slit. Therefore, as compared with the case where the bundle-like wire group is pushed into the slit of the conventional arranging jig, fixedly mounted on the installation plate, by moving only the wire group, the efficiency of the insertion of the wire group 133 into the slit 243 can be enhanced.

In the wire holding member 239, the bundle-like wire group 133 is brought into contact with the inner side of the longer leg portion 240a, and while the untied wire group 133 and the wire holding member 239 are both moved, the wires can be introduced into the slit 243 along the longer leg portion 240a. Therefore, the wire holding member 239 can be moved to that portion of the untied wire group 133 which can be easily introduced, thereby directing the opening between the leg portions 240a and 240b toward this portion. Therefore, as compared with the case where the bundle-like wire group is pushed into the slit of the conventional arranging jig, fixedly mounted on the installation plate, by moving only the wire group, the wires can be more efficiently introduced into the slit 243.

Further another modification of the first embodiment is described below.

In this modification, as shown in FIGS. 18A and 18B, fixing holes 236 for respectively receiving distal ends of longer leg portions (described later) of the wire holding members 239 are formed respectively through those portions of the installation plate 235 corresponding respectively to opposite ends of a predetermined portion of the wire harness spaced from each other in a wire-installing direction.

One leg portion 240a is longer than the other leg portion 240b by an amount (length) L. When the distal end of the one leg portion 240a is inserted into the fixing hole 236 in the installation plate 235, the lower end surface of the other leg portion 240b is abutted against the installation plate 235, thereby preventing the further insertion of the leg portion 240a, and the wire holding member 239 is fixed to the installation plate 235 in a self-standing manner.

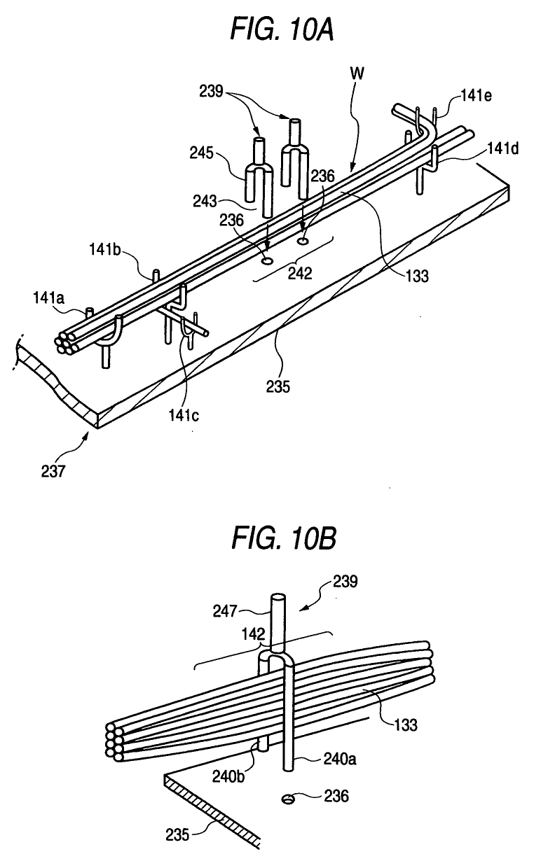

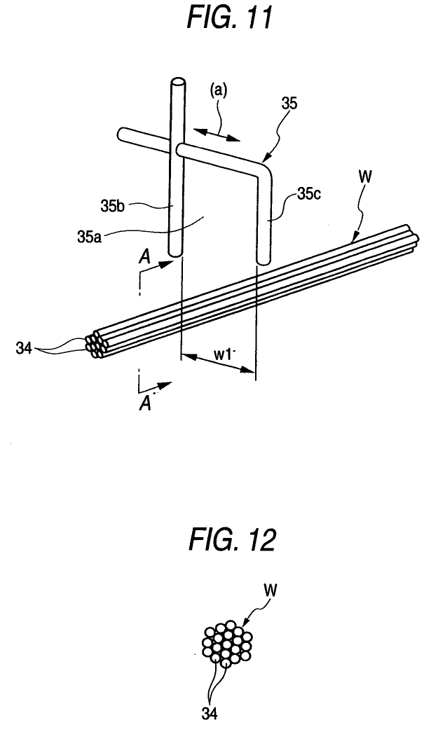

Then, the wire holding member 239, having its open end directed downward, is moved downward from the upper side of the installation plate 235, and is brought into clamping engagement with that portion of the wire group 133 disposed at one of the opposite ends of the predetermined portion 242 (disposed between the wire group support jigs 141b and 141d) spaced from each other in the wire-installing direction, as shown in FIG. 10B. During this clamping operation, the wire group 133, tied into the bundle of the round cross-sectional shape, is untied, and the wires are inserted one by one into the slit 243, and are moved upward in the slit 243. Therefore, the wires are fed upward in the slit 243 in the order of insertion of these wires.

The wire group 133 is thus inserted into the slit 243, so that the wire group 133 is arranged in one row in the vertical direction as shown in FIG. 5A. After the wire group 133 is arranged in the slit 243 in the wire holding member 239, the one leg portion 240a is inserted into the fixing hole 236. As a result, the wire holding member 239, arranging the wire group 133, is fixed to the installation plate 235. After the wire holding member 239 is thus brought into clamping engagement with that portion of the wire group 133 disposed at the one of the opposite ends of the predetermined portion 242 spaced from each other in the wire-installing direction, the other wire holding member 239 is similarly brought into clamping engagement with that portion of the wire group 133 disposed at the other of the opposite ends of the predetermined portion 242 spaced from each other in the wire-installing direction. As a result, those portions of the wire harness W, disposed respectively at the opposite ends of the predetermined portion 242 spaced from each other in the wire-installing direction, are clamped respectively by the pair of wire holding members 239, so that the predetermined portion 242 is neatly arranged in the vertical direction.

In this case, the wire holding member 239 can be detached from the installation plate 235 merely by removing the one leg portion 240a from the fixing hole 236 without the need for a cumbersome nut-removing operation as required in the conventional method.

And besides, one (240a) of the pair of leg portions 240a and 240b of the wire holding member 239, forming the slit 243 therebetween, is inserted into the fixing hole 236 formed in the installation plate 235, and by doing so, the wire holding member 239 can be fixed to the installation plate 235. Therefore, when arranging the wire group 133, the leg portion 240a is inserted into the fixing hole 236, and after the coating of the water stop agent, the leg portion 240a is removed from the fixing hole 236, and merely by doing so, the fixing and removal of the wire holding member 239 can be effected easily, thereby enhancing the efficiency of the operation.

In the above arranging jig 237 for arranging the wire harness W, the forming portions 245 of the wire holding members 239 are brought respectively into clamping engagement with those portions of the wire harness W, disposed respectively at the opposite ends of the predetermined portion 242 of the wire harness W, from the upper side of the wire group 133, with each handle portion 247 grasped by the hand, and the bundle-like wire group 133, while gradually disintegrated, can be inserted into the slit 243 therealong without an undue force. As a result, the predetermined portion 242 of the wire group 133, clamped at its opposite ends respectively by the wire holding members 239, can be arranged in the vertical direction in such a manner that the arranged wire group has the predetermined thickness. Then, the one leg portion 240a of the wire holding member 239 is inserted into the fixing hole 236, with the wire group 133 received in the slit 243, and by doing so, the wire holding member 239, arranging the wire group 133, can be easily fixed to the installation plate 235. At the same time, the predetermined portion 242 of the wire harness W to be coated with the water stop agent can be accurately located in the proper position.

### Second Embodiment

Another preferred embodiment of a wire harness arranging-purpose wire holding member of the present invention, as well as a wire harness-arranging method of the invention, will be described in detail with reference to the drawings.

FIGS. 11 and 13 show one preferred embodiment of the wire harness arranging-purpose wire holding member of the invention.

The wire holding member 35 of this embodiment is used, for example, in the process of arranging those portions of a plurality of wires 34, which are to be passed through a vehicle body panel, in a row, and then coating a water stop agent onto these portions of the wires so as to tie the vehicle body panel-passing portion of a wire harness W into a waterproof structure.

Unlike the conventional wire holding members, fixedly mounted on the arranging jig on the installation plate (see FIG. 20) for shaping the wire group of the wire harness into the predetermined installation form corresponding to the installation form on the vehicle, the wire holding member 35 of this embodiment is separate from the installation plate, and is provided, for example, above the installation plate so as to move toward and away from the wire harness on the installation plate, and this wire holding member is applied later to a predetermined portion of the wire harness, arranged on the installation plate, so as to arrange those portions of the wires, forming the mounting portion, in one row.

As shown in the drawings, the wire holding member 35 of this embodiment includes a first arm 35b, extending in a direction intersecting the wire harness W arranged or installed on the installation plate or the like, and a second arm 35c which is opposed to the first arm 35b, and is spaced such a distance from the first arm 35b that the wire harness W can pass between the first and second arms 35b and 35c.

In this embodiment, the first arm 35b and the second arm 35c are both formed of a bar-like material. A proximal end portion of the second arm 35c is slidably fitted in a proximal end of the first arm 35b, and by sliding the second arm in a direction of arrow (a) in FIG. 11, the distance between the second arm 35c and the first arm 35b can be adjusted.

Namely, a slit 35a, serving as a gap for the passage of the wire harness W therethrough, is provided between the first and second arms 35b and 35c, and by sliding the second arm 35c, the width of this slit 35a can be adjusted, that is, changed from a value, larger than the outer diameter of the wire harness W, to a value substantially equal to the diameter of the single wire 34.

The first and second arms 35b and 35c of the wire holding member 35 clamp and hold the wires 34 of the wire harness W therebetween.

In the wire harness-arranging method of the present invention, a portion, arranged in a row, is formed at a predetermined portion of the wire harness W, using the wire holding member 35. First, the distance w1 between the first and second arms 35b and 35c of the wire holding member 35 is made larger than the outer diameter of the wire harness W as shown in FIG. 11, and in this condition the wire harness W is passed through the slit 35a formed between the first and second arms 35b and 35c. Then, the distance between the first and second arms 35b and 35c is reduced as indicated by arrow (b) in FIG. 13 so as to press the group of wires 34, passing between the first and second arms 35b and 35c, thereby arranging the wires 34 of the wire harness W in a row.

FIGS. 13 and 14 show the case where the distance between the first and second arms 35b and 35c is so adjusted that the wires 34 are arranged in two rows. By further reducing the distance between the first and second arms 35b and 35c, the plurality of wires 34 can be arranged vertically in a row.

When a portion, arranged in a row, is to be formed on the wire harness W over a predetermined length thereof, for example, for coating the water stop agent, two wire holding members 35 are used as shown in FIG. 13 in which the additional wire holding member is indicated by dots-and-dash lines.

First, the wires 34 are arranged in a row by the two wire holding members 35 disposed near to each other, and then one wire holding member 35 is slid along the thus held wires 34 as indicated by arrow (c) in FIG. 13, thereby increasing the distance between the two wire holding members 35 into a predetermined value. By doing so, the portion, arranged in one row, can be easily formed on the wire harness over the predetermined length thereof.

In the above wire holding member 35 and the wire harness-arranging method using this wire holding member 35, the distance between the first and second arms 35b and 35c of the wire holding member 35 is beforehand made larger than the outer diameter of the bundle of wires 34 forming wire harness W, and by dosing so, the plurality of wires 34 of the wire harness W can be held by the wire holding member 35 at a time by one inserting operation, and therefore in contrast with the conventional wire holding member 14 having the fixed slit width, it is not necessary to pass the wires 34 one by one through the slit.

After the bundle of wires 34 of the wire harness W are passed between the first and second arms 35b and 35c of the wire holding member 35, the distance between the first and second arms 35b and 35c of the wire holding member 35 is reduced, and with this simple operation, the plurality of wires 34, held by the wire holding member 35, are pressed, and can be easily arranged in one row.

Therefore, the time and labor, required for holding the plurality of wires, forming the wire harness, in a manner to arrange these wires in a row, are much reduced, thereby greatly enhancing the efficiency of the operation.

Even when the diameter of the wires 34 to be held by the wire holding member is changed, this can be easily dealt with merely by adjusting the distance between the first and second arms 35b and 35c since this distance between the two arms is adjustable. Thus, the wire holding member 35 has the enhanced general-purpose ability, and therefore the requirement for the change of the diameter of the wires 34 of the wire harness W and so on can be rapidly met without the need for producing a new wire holding member.

Therefore, the number of the wire holding members 35, prepared for the production of the wire harness W, is prevented from increasing, and the management costs for the wire holding members 35 and jigs are saved, thereby reducing the production cost.

The specific mechanism for adjusting the distance between the first and second arms of the wire holding member is not limited to the above embodiment.

Although a simple mechanism is preferred, any other suitable known slide mechanism can be used.

### Third Embodiment

The third embodiment of the invention will now be described in detail with reference to the drawings.

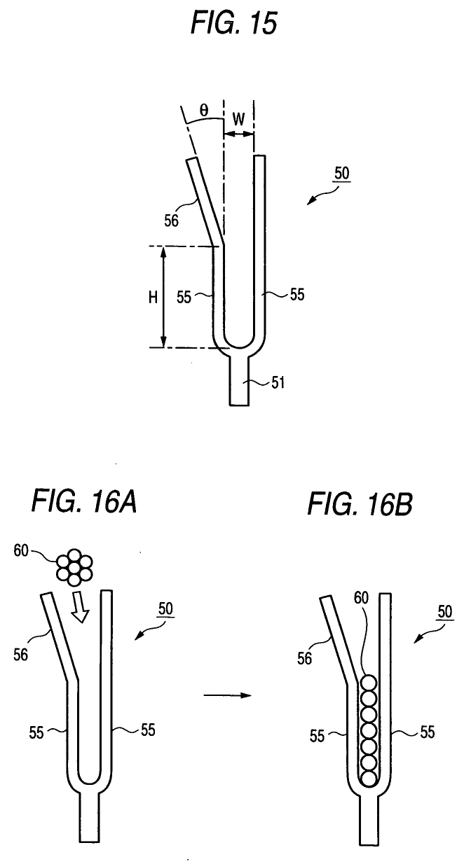

FIG. 15 is a plan view showing one preferred embodiment of a water-stopping treatment jig of the invention. As shown in the drawings, the water stopping-treatment jig 50 includes a pair of wire support piece portions 55 and 55 extending in a bifurcated manner from a base portion 51, and a distal end portion 56 of one (here, the left one in the drawings) of the wire support piece portions 55 is slanting gradually away from the other wire support piece portion 55 over a predetermined length. In the description given below, the slanting distal end portion 56 will be also referred to as “slanting portion 56”.

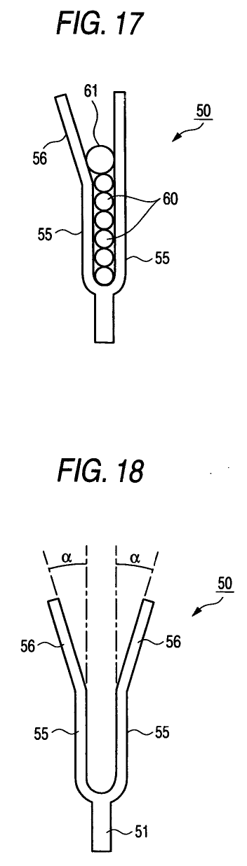

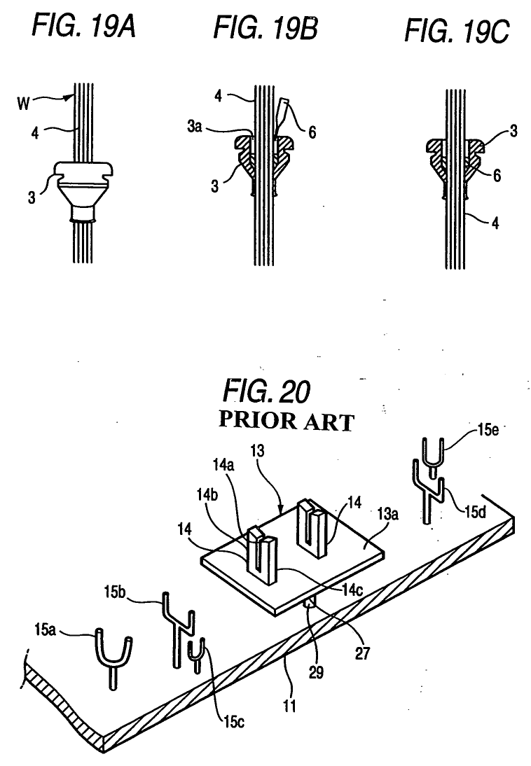

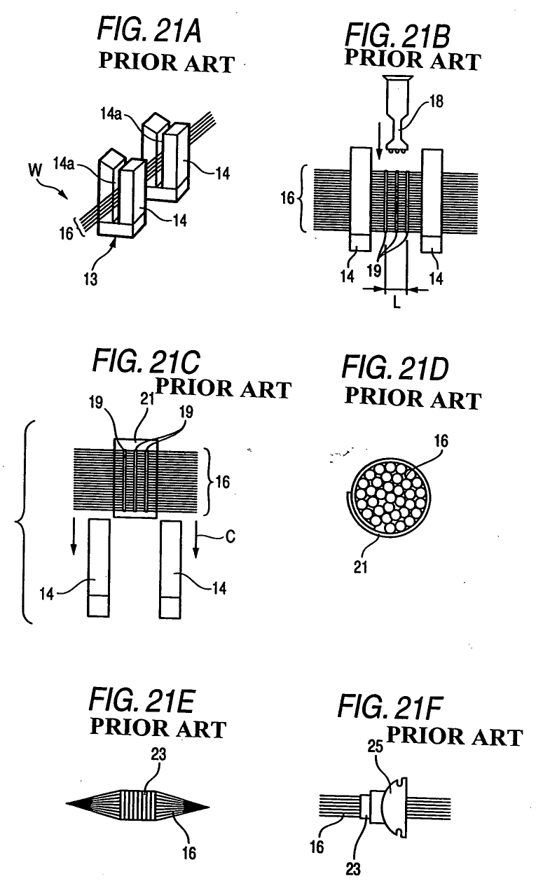

A width W of a slit between the pair of wire support piece portions 55 and 55 is slightly larger than an outer diameter of wires to be treated, and the distance H from the bottom of this slit to an inclination-starting point of the slanting portion 56 is determined in accordance with the number of the wires to be treated. An inclination angle θ of the slanting portion 56 is determined in accordance with an outer diameter of a wire bundle 60 (shown in FIGS. 16A and 16B) or an outer diameter of a thick wire 61 (shown in FIG. 17). The slanting portion 56 can be formed into other shape (for example, an arcuate shape) than the illustrated straight shape.

Each of the base portion 51, the wire support piece portions 55 and the slanting portion 26 may have a bar-like shape, or may have an increased thickness in a direction perpendicular to the sheet of the drawings. As another alternative, the provision of the base portion 51 can be omitted, and the pair of wire support piece portions 55 and 55 can be directly formed upright on a flat plate.

The upper portion of the water-stopping treatment jig 50 is wide open because of the provision of the slanting portion 56, and therefore the insertion of the wires into this jig can be effected quite easily.

And besides, the wire bundle, comprising the plurality of wires 60, can be handled in its original condition as shown in FIGS. 16A and 16B. More specifically, the wire bundle can be inserted into the jig, utilizing the wide opening provided by the slanting portion 56, as shown in FIG. 16A, and further this wire bundle can be disintegrated into the individual wires 60 while the bundle moves down along the slanting portion 56. Finally, the individual wires 60 can be arranged vertically in a row between the pair of wire support piece portions 55 and 55 as shown in FIG. 16B.

Furthermore, the thick wire 61 and the wires 60 of a smaller diameter can be handled at the same time as shown in FIG. 17. More specifically, the wires 60 of the smaller diameter are arranged vertically in one row by the pair of wire support piece portions 55 and 55, and the thick wire 61 is supported by the slanting portion 56 and that wire support piece portion 55 opposed to this slanting portion 56, and by doing so, the wires 60 of the smaller diameter and the thick wire 61 can be arranged vertically in one row as a whole.

FIG. 18 shows a modified example of the water-stopping treatment jig 50 of the invention, and in this modified example, the slanting portion 56 is provided at each of two wire support piece portions 55 and 55. Here, an inclination angle α of each of the two slanting portions 56 and 56 is determined in accordance with the outer diameter of the wire bundle to be treated and the outer diameter of the thick wire to be treated. This modified water-stopping treatment jig 50 can also handle the thick wire and the wire bundle in the manner shown in FIGS. 16A, 16B and 17.

The wire harness to be processed by the member and method of the present invention is not limited to the automotive wire harness. The invention is useful for various wire harnesses in which wires need to be arranged in a row in the producing process or the installing process.

And besides, the use of the present invention is not limited to the coating of the water stop agent so as to obtain the waterproof structure described in the above embodiment. For example, the invention can be applied to the case where wires need to be-arranged in a row in a connector-connecting operation and the like, and in addition the invention can be used in various operation steps in which wires need to be arranged in a row.

The wire harness arranging-purpose wire holding member of the invention is provided so as to move relative to the installation plate for shaping the wire harness into the predetermined installation form. Instead, the wire holding member can be used as a general-purpose tool, which is completely independent of the installation plate or the like, so that it can be used for various purposes.

As described above, in the wire harness arranging-purpose wire holding member of the invention and the wire harness-arranging method of the invention, the distance between the first and second arms of the wire holding member is beforehand made larger than the outer diameter of the bundle of wires forming the wire harness, and by dosing so, the plurality of wires of the wire harness can be held by the wire holding member at a time by one inserting operation, and therefore in contrast with the conventional wire holding member having the fixed slit width, it is not necessary to pass the wires one by one through the slit.

After the bundle of wires of the wire harness are passed between the first and second arms of the wire holding member, the distance between the first and second arms of the wire holding member is reduced, and with this simple operation, the plurality of wires, held by the wire holding member, can be pressed, and can be easily arranged in one row.

Therefore, the time and labor, required for holding the plurality of wires, forming the wire harness, in a manner to arrange these wires in a row, are much reduced, thereby greatly enhancing the efficiency of the operation.

Even when the diameter of the wires to be held by the wire holding member is changed, this can be easily dealt with merely by adjusting the distance between the first and second arms since this distance between the two arms is adjustable. Thus, the wire holding member has the enhanced general-purpose ability, and therefore the requirement for the change of the diameter of the wires of the wire harness and so on can be rapidly met without the need for producing a new wire holding member.

Therefore, the number of kinds of the wire holding members, prepared for the production of the wire harness, is prevented from increasing, so that the production cost can be reduced.

Further, in the present invention, there is provided the wire harness water-stopping treatment jig in which the wires can be arranged easily when coating the water stop agent onto the wires, and besides the thick wire and the wire bundle can be handled at the same time.

In the wire harness-arranging method of the present invention, the wire harness is supported above the installation plate in spaced relation thereto, and then the U-shaped wire holding members, each having the slit of a uniform width, are brought respectively into clamping engagement with those portions of the wire group, disposed respectively at the opposite ends of the predetermined portion of the wire harness spaced from each other in the wire-installing direction, from the upper side of the installation plate. By doing so, the wire group at the predetermined portion are arranged along the slits of the wire holding members in the vertical direction. Therefore, it is not necessary to install the wire harness while inserting the wire harness into the arranging jig much projecting in the vertical direction, and therefore the efficiency of the wire-arranging operation is enhanced. And besides, it is not necessary to insert the wire harness into the arranging jig, much projecting in the vertical direction, while bending the wire harness, and therefore a slack will not develop in the wire harness. Each wire holding member can be brought into clamping engagement with the wire group, already supported on the installation plate, from the upper side, and therefore an undue pushing force will not act on the wire group, and the wires are prevented from being damaged.

The wire harness-arranging jig of the invention comprises the wire holding members each including the forming portion of a U-shape, having the slit of a uniform width and the open distal end, and the handle portion extending from the rear end of the forming portion remote from the open end thereof. Therefore, the forming portions are gradually brought respectively into clamping engagement with those portions of the wire harness, disposed respectively at the opposite ends of the predetermined portion of the wire harness supported on the installation plate, from the upper side of the wire group, with each handle portion grasped by the hand, and by doing so, the wire group can be arranged in the vertical direction along the slits without an undue force in such a manner that the arranged wire group has the predetermined thickness.

As described in detail, in the wire harness-arranging method of the present invention, the wire harness is supported on the installation plate, and then the inner sides of the longer legs portions of the wire holding members are brought respectively into contact with those portions of the wire group disposed respectively at the opposite ends of the predetermined portion of the wire harness spaced from each other in the wire-installing direction, and the wire group, while kept in sliding contact with the longer leg portion, is introduced into the slit, and is arranged in the slit. Therefore, while the wire holding member, held by one hand, and the wire group, held by the other hand, are moved relative to each other, the wires can be sequentially introduced into the slit. Therefore, as compared with the case where the bundle-like wire group is pushed into the slit of the conventional arranging jig, fixedly mounted on the installation plate, by moving only the wire group, the efficiency of the insertion of the wire group into the slit can be enhanced, and the productivity of the wire harnesses can be enhanced.

In the arranging jig of the present invention, the wire holding member has the slit of a uniform width formed between the pair of leg portions, and the handle portion extends from the rear ends of the leg portions, and the width of the slit is substantially equal to the thickness of the arranged wire group of the predetermined portion of the wire harness in the direction perpendicular to the direction of arrangement of the wire group. The two leg portions are different in length from each other. Therefore, the bundle-like wire group is brought into contact with the inner side of the longer leg portion, and while the untied wire group and the wire holding member are both moved, the wires can be introduced into the slit along the longer leg portion. Namely, the opening between the two leg portions can be directed toward that portion of the untied wire group which can be easily introduced. Therefore, as compared with the case where the bundle-like wire group is pushed into the slit of the conventional arranging jig, fixedly mounted on the installation plate, by moving only the wire group, the wires can be more efficiently introduced into the slit.

As described above in detail, in the wire harness-arranging method of the present invention, the wire harness is supported above the installation plate in spaced relation thereto, and then the U-shaped wire holding members, each having the slit of a uniform width, are brought respectively into clamping engagement with those portions of the wire group, disposed respectively at the opposite ends of the predetermined portion of the wire harness spaced from each other in the wire-installing direction, from the upper side of the installation plate. By doing so, the wire group at the predetermined portion are arranged along the slits of the wire holding members in the vertical direction. Therefore, it is not necessary to install the wire harness while inserting the wire harness into the arranging jig much projecting in the vertical direction, and therefore the efficiency of the wire-arranging operation is enhanced. And besides, it is not necessary to insert the wire harness into the arranging jig, much projecting in the vertical direction, while bending the wire harness, and therefore a slack will not develop in the wire harness. One of the pair of leg portions of the wire holding member, forming the slit therebetween, is inserted into the fixing hole formed in the installation plate, and by doing so, the wire holding member can be fixed to the installation plate. Therefore, when arranging the wire group, the leg portion is inserted into the fixing hole, and after the coating of the water stop agent, the leg portion is removed from the fixing hole, and merely by doing so, the fixing and removal of the wire holding member can be effected easily, thereby enhancing the efficiency of the operation.

The wire harness-arranging jig of the invention comprises the wire holding members, each including the forming portion of a U-shape having the slit of a uniform width formed between the pair of leg portions of different lengths, and the handle portion extending from the rear end of said forming portion, and the installation plate having the fixing holes for respectively receiving the distal ends of the longer leg portions of the wire holding members. The forming portions of the wire holding members are gradually brought respectively into clamping engagement with those portions of the wire harness, disposed respectively at the opposite ends of the predetermined portion of the wire harness, from the upper side of the wire group, with each handle portion grasped by the hand, and by doing so, the wire group can be arranged along the slits in the vertical direction in such a manner that the arranged wire group has the predetermined thickness. Then, the one leg portion of the wire holding member is inserted into the fixing hole, with the wire group received in the slit, and by doing so, the wire holding member, arranging the wire group, can be easily fixed to the installation plate.

1. (canceled)

2. (canceled)

3. A wire harness-arranging jig wherein wires of a wire harness is untied and arranged at a predetermined portion so as to be coated with a water stop agent, comprising:
a wire holding member including a U-shaped forming portion having a slit of a uniform width and an open distal end, and
a handle portion extending from a rear end of said forming portion remote from said open end thereof, said forming portion being adapted to arrange said wires along said slit;
wherein the uniform width of said slit is substantially equal to a thickness of the wires at said predetermined portion in a direction perpendicular to a direction of arrangement of said wires.

4. (canceled)

5. (canceled)

6. A wire harness-arranging jig wherein a wire group at a predetermined portion of a wire harness provided with a plurality of bundled wires, is untied and arranged for coating a water stop agent; comprising:
a wire holding member provided with a pair of leg portions forming a slit of a uniform width therebetween and a handle portion extending from rear ends of said leg portions;
wherein said width of said slit is substantially equal to a thickness of the arranged wire group at said predetermined portion in a direction perpendicular to a direction of arrangement of said wire group, and said leg portions are different in length from each other.

7. (canceled)

8. (canceled)

9. A wire harness-arranging device wherein a wire group at a predetermined portion of a wire harness provided with a plurality of bundled wires is untied and arranged for coating a water stop agent; comprising:
a wire holding member including
a U-shaped forming portion having a pair of leg portions of different lengths forming a slit with a uniform width therebetween and an open distal end, and
a handle portion extending from a rear end of said forming portion remote from said open end thereof,
said forming portion being adapted to arrange said wire group along said slit, and the uniform width of said slit being substantially equal to a thickness of the arranged wire group of said predetermined portion in a direction perpendicular to a direction of arrangement of said wire group; and
an installation plate including a plurality of wire group support jigs mounted thereon for supporting said wire group in a branched pattern corresponding to a predetermined installation form;
wherein a fixing hole is formed on said installation plate for receiving a distal end of the longer leg portion of said wire holding member at least a position corresponding to one of both ends of said predetermined portion in a wire-installing direction.

10. A wire harness-arranging device according to claim 9, wherein the fixing holes are provided on positions corresponding to both ends of said predetermined portion in the wire-installing direction, respectively.

11. A wire harness-arranging jig according to claim 3,
wherein said forming portion including
a first arm extending in a direction intersecting the wires; and
a second arm which is opposed to said first arm and is spaced such a distance from said first arm so that said wires pass between said first and second arms;
wherein said second arm is supported on said first arm in such a manner that a distance between said first and second arms is reduced to a value substantially equal to a diameter of said wires, and said first and second arms can clamp and hold said wires of said wire harness therebetween.

12. (canceled)

13. A wire harness water-stopping treatment jig for forming a grommet-passing portion of a wire harness with a waterproof structure when a plurality of wires are tied into a predetermined installation form, comprising:
a pair of opposed wire support piece portions;
wherein a distal end portion of at least one of said wire support piece portions is slanting gradually away from the other of said wire support piece portions over a predetermined length.

14. A wire harness water-stopping treatment jig according to claim 13, wherein a width of a slit between said pair of wire support piece portions is slightly larger than an outer diameter of said wires, and a distance from a bottom of said slit to an inclination-starting point of said slanting portion is determined in accordance with a number of the wires.
